(19) United States
(12) Patent Application Publication
(10) Pub. No.: US 2002/0106049 A1
(43) Pub. Date: Aug. 8, 2002

(54) Control element for a nuclear reactor

(76) Inventor: Wolfgang Schulz, Wolpinghausen (DE)

Correspondence Address: WILLIAM COLLARD, COLLARD & ROE, P.C., 1077 NORTHERN BOULEVARD, ROSLYN, NY, 11576, US

(21) Appl. No.: 09/765,135

(22) Filed: Jan. 18, 2001

Related U.S. Application Data
(63) Continuation-in-part of application No. 09/265,738, filed on Mar. 10, 1999, now abandoned.

(30) Foreign Application Priority Data
Mar. 11, 1998 (DE) 198 10 433.2

(51) Int. Cl. G21C 3/32

(52) U.S. Cl. 376/447

(57) ABSTRACT

A control element for a nuclear reactor includes an absorber and at least three absorber enclosures for receiving the absorber. The absorber enclosure is constructed in such a way that the received absorber can be subjected to local relative burn up of more than 90% without the burnt-off absorber material getting into the reactor coolant. The control element is constructed in such a way that there are at least three absorber enclosures and a predetermined spacing between the enclosures, so that each absorber enclosure forms a mechanical resistance for the absorber and is removable from the starting position in the event of expansion of the absorber.

### BACKGROUND OF THE INVENTION

1. Field of the Invention

The present invention relates to a control element for a nuclear reactor, with an absorber and with at least one inner absorber enclosure and one outer absorber enclosure for receiving the absorber.

2. The Prior Art

The term “control element” generally denotes control assemblies for pressurized water reactors and control rods for boiling water reactors. These control elements are required for controlling the reactor power and also have to be capable of safely shutting down the reactor under any operating condition. The control elements are inserted in or between the fuel elements or nuclear fuel rods in order to absorb neutrons and to control in this way the chain reaction.

In boiling water reactors, the control elements are raised into the bottom of the fuel elements, for example in large power nuclear reactors just to such an extent that of the neutrons liberated in a nuclear fission, exactly one neutron on the average will again induce a further nuclear fission.

The nuclear lifetime of an original equipment boiling water reactor control element is reached, when the top quarter segment reaches a 10% reduction in reactivity cold worth

$$( \underline{\frac{Δ k}{k}} < 10 \% ) .$$

The end-of-life reactivity worth reduction will account for any effects of absorber depletion. In this case, by using B-10 as the neutron absorber material absorber depletion is defined as the ratio of the amount of B-10 atoms that “burn up” in relation to the original amount of B-10 atoms.

The most direct comprehensive experiments concerning the burn up of B-10 in B₄C and the tritium release from B₄C were conducted by Miles, C. C., Wexler, S., Ebersole, E. R. in “TRITIUM RETENTION IN EBR-II-IRRADIATED BORON CARBIDE” in ANL-8107, JUIN 1974, who showed by careful analytical chemistry measurements that the tritium in B₄C is formed in proportion relation to the B-10 burn up according to the following reactions:

¹⁰B+n→⁷Li+⁴He+2,79MeV (thermal neutrons); (1)

⁷Li+n→⁴He+³H+n (fast neutrons) (1a)

¹⁰B+n→2⁴He+³H+0,23MeV (fast neutrons) (2)

The experimental database shows that the irradiation induced damage to B₄C is primarily due to the formation of large amounts of helium and lithium and the subsequent accommodation of these atoms in the B₄C structure.

The control element end-of-life depletion values can be converted to fluence (snvt) values consistent with the process computer TCREX array.

The process computer accumulates the fuel exposure adjacent to each quarter axial segment of every control element and converts the control element exposure to fluence values. The fluence values are accumulated for each quarter axial control element segment and represents the fuel and control element smeared thermal fluence. This smeared thermal fluence is in a proportional relation to the axial control element quarter segment averaged B-10 depletion. This includes the B-10 depletion averaged over every absorber rod with respect to the four wings within a control element quarter segment.

The control element which is adapted to be inserted into and extracted from the nuclear core, is not uniformly exposed to neutrons. For instance, the rate of neutron exposure is high at the side edges and the upper end of each of the four blades. This means, that these portions of the control blade absorb greater amounts of neutrons than other portions of the control blade. These local depletion effects are taken into account by defining axial and radial peaking factors named fₐₓ and f_{rad}. So a local B-10 depletion or a local B-10 burn up axially and radially located at a special point of a special concentric (boron) absorber means the number of B-10 atoms in relation to the original amount of B-10 atoms defined as the “local” burn up percentage αₘ.

But even since the “local” burn up percentage αₘ differs radially with respect to its absorber diameter αₘ, this represents an averaged B-10 burn up profile in a radial direction to the center of the cylindrical absorber section—this had been verified by basic irradiation tests conducted in the Hanford KE and KW production reactors Washington, USA by A. L. Pitner and G. E. Russcher, described in “IRRADIATION OF BORON CARBIDE PELLETS AND POWDERS IN HANFORD THERMAL REACTORS”, Wadco Corporation, Richland, Washington December 1970, UC-25, Metals, Ceramics and Materials before the year 1970.

For determining burn up levels and reaction profiles, 90 cylindrical B₄C samples had been exposed to thermal neutrons. Burn up had been measured by spectrometic analysis of the ¹⁰B/¹¹B ratio at the beginning and after exposure increments.

To establish the relationships between irradiation exposure and average ¹⁰B burn up αₘ for these specimen, 500 different cylindrical shells had been used to calculate the mentioned averaged relative burn-up percentage αₘ for the entire B₄C sample—this by using the Shell Model and taking into account self shielding kernels. FIG. 1A shows the original measured (averaged with respect to the cross-section of the absorber pellet) burn up percentage αₘ (original titled “AVE BURNUP \overline{BU}”) of an absorber pellet together with an illustrative local B 10 burn up distribution with respect to the radial burn-up location. The related burn-up distributions had been determined for small B₄C Pellets showing different B₄C densities and different neutron fluences.

This relationship between irradiation exposure φ and averaged B-10 burn up percentage αₘ with respect to a cylindrical absorber specimen represents the basic expression

$$φ = \frac{{a}_{m}}{α}$$

whereas α represents a proportionality factor to correlate or to translate the accumulated neutron fluences φ in the fuel bundles adjacent to the control element to absorptions in the cylindrical absorbers.

However, re-analyzation of those very first investigations showed that the relationship between specimen averaged burn up percentage αₘ and the local burn up distribution α(r), a burn up function with respect to the absorber radius, calculated by the help of the “shell model” needs to be modified by using the “Microscopic Burn-up Theory” developed by the applicant and described in his dissertation in detail. This modification is verified to be in agreement according to the equation of reactions by Miles, C. C., Wexler, S., Ebersole, E. R describing the different B-10 burn up reactions.

So in the present invention, the term “burn up percentage αₘ” quite generally denotes a special point at a control element where the B-10 burn up averaged in a radial direction over its cylindrical absorber section generally shows a maximum in contrast to other locations of the control element.

The local burn-up percentage a generally denotes in the present invention a local burn up percentage at one point on the radial burn-up distribution α(r) with respect to the absorber axis of a cylindrical absorber having an averaged burn up percentage αₘ at the mentioned special point of the control element, where the B-10 burn up averaged in radially direction over its cylindrical absorber section generally shows a maximum in contrast to other locations of the control element.

If the control elements are to be employed for a reactor service life of about 40 operating years, it must be possible to load the control elements with a certain neutron fluence without causing the efficiency of the control elements to decrease by more than 10% as compared to their original efficiency.

Furthermore, the control elements are expected to contribute to satisfying the overriding protective goals for maintaining the integrity of the barriers against radioactivity releases from the reactor cooling system.

It has been found that nuclear control elements belong to the consumed materials because the absorber material strongly expands due to the capturing of neutrons. This leads to mechanical damage to the absorber enclosure with subsequent leaching of the absorber material. If such a control element is used further in the active core zone, this leads to an increase in the local power density distribution in the core. Under certain circumstances, it may even cause damage to the fuel rods in addition to the release of tritium into the biosphere.

An adaptation and optimization of the control elements in view of their useful life, however, is limited by the preset geometry of the reactor, in particular by the geometry of the free water gaps between the fuel element boxes in boiling water reactors, and by the geometry of the control rod guide tubes in pressurized water reactors. Attempts have previously been made to prolong the useful life of the absorber enclosures and thus of the control elements as much as possible. This is through selection of the material of the absorber enclosure and of the wall thickness of the absorber enclosure. The success of these attempts, however, was limited.

A control element for a nuclear reactor is known from DE 39 03 844 A1. Inner tubes receiving the absorber are inserted in this reactor into a receiving hole. It is proposed according to DE 41 38 030 A1 to provide in the control rods for elongated ducts or channels, in which a swelling material can expand.

Other control elements are described, for example in EP 0 143 661; U.S. Pat. No. 4,861,544; and U.S. Pat. No. 4,929,412.

Control elements especially for pressurized water reactors are described also, for example in “Design of Siemens Control Assemblies For Pressurized Water Reactors Ancl Operational Experience” by L. Heins, W. Dambietz, and H. P. Fuchs in Kerntechnik 57 (1992), No. 2, pages 84 to 89 (Carl Hanser Verlag, Munich). A further description of control elements of this type is contained in “ABB Control Rods” by G. Vesterlund et al, in Kerntechnik 57 (1992), No. 2, pp 105 and 106 (Carl Hanser Verlag, Munich).

### SUMMARY OF THE INVENTION

It is an object of the present invention to provide a control element for a nuclear reactor which can be subjected to a particularly high burn up percentage αₘ and in that way to particularly high axial control element quarter segment smeared B-10 depletion.

According to the present invention, the absorber enclosure is acting as a limiting device with respect to the swelling behavior of the neutron absorbing material; the limiting device in the present invention generally being denoted to absorber enclosure is arranged in a starting position adjoining the absorber. Thus it forms a mechanical resistance for the absorber; and the absorber enclosure is removable from the starting position when the absorber expands. Overall, an absorber enclosure is created in this way which, through counterpressure, prevents uncontrolled and very rapid swelling of the absorber. However, when the absorber enclosure is no longer capable of withstanding the swelling absorber, the absorber enclosure yields when a certain expansion is reached. The absorber enclosure may then be removable from the starting position in that it breaks or gets destroyed, or by guiding it in a controlled way to the outside, where it continues to form a mechanical resistance for the absorber. The term “removable”, therefore, is to be understood to mean that the absorber enclosure is either actually spatially removed from its starting or initial position or loses its directly limiting function in which it exerts pressure inwardly. Thus the absorber enclosure breaks up or gets destroyed in some other way, whereas residual parts, however, remain physically in the initial position. The control element so created may be subjected to burn up αₘ of almost 100% without burnt-off absorber material getting into the reactor coolant.

In another embodiment of the present invention, provision is made for at least three absorber enclosures, and whereby provision is made, furthermore, for a predetermined spacing between the absorber enclosures surrounding and embracing one another. Upon expansion of the absorber, the respective absorber enclosure is removable from its initial position and mechanical resistance is provided for the absorber.

The outer absorber enclosure then forms a solid outer jacket, whereas the inner absorber enclosure initially abuts the absorber and offers resistance to the swelling absorber. However, the inner absorber enclosure breaks apart at a defined pressure, so that the absorber can continue to expand in the direction of the outer absorber enclosure. The inner absorber enclosure may also form, for example a semicircle adjacent to the outer absorber enclosure.

In a further embodiment of the present invention, provision is made for three or more absorber enclosures surrounding and adjacent to one another because it is possible in this way to offer the swelling absorber several resistances in a staggered and easily presettable manner. These resistances will yield one after the other and in this way will permit a particular operating duration of the control element, during which the absorber material can be completely burned up. A predetermined spacing is provided for in this embodiment between the absorber enclosures adjacent to one another. Thus the absorber enclosure disposed in the innermost position at a given time can break or be destroyed in some other way without damaging in this process the adjacent next outer absorber enclosure.

The predetermined spacing is determined depending on the effective creep deformation ε up to breakage of the material employed. Thus the absorber enclosure is first still capable of expanding within the predetermined spacing under the pressure of the absorber material before breakage of the absorber enclosure can occur.

It is a particularly preferred embodiment of the invention that the absorber enclosures are designed in such a way that the outer absorber enclosure completely envelops and surrounds the inner absorber enclosure. Therefore, this system has a plurality of absorber enclosures which are fitted or nested into each other, which initially offer resistance pressure to the absorber expanding from the inside outwardly. These enclosures are preferably concentric and then yield to the expansion pressure and break. Thus the absorber enclosure disposed next to the further swelling absorber establishes mechanical pressure compressing the absorber and effectively prevents uncontrolled swelling expansion of the absorber.

In another embodiment of the invention, the limiting device is made of an elastic and heat-resistant material, which is attached from the inside to the outer absorber enclosure. Such a material would first apply pressure inwardly to the expanding absorber, but then yield to the increasing pressure of the absorber, forcing it outwardly. In a further embodiment, the absorber enclosure has mechanical mobility, so that it comprises, for example movable half shells. These half shells are pressed against the absorber by a mechanical element, for example by springs or other elastic intermediate elements, and removed under the pressure of the absorber from the starting position and pressed outwardly.

In a preferred embodiment of the invention, the dimensions of the inner absorber enclosure are selected in such a way that the inner absorber enclosure is suitable for receiving preset sintered absorber tablets. Also, it is possible to employ a powder as the absorber. B₄C is preferably used as the absorber. B₄C shows an excellent neutron-absorbing cross-section, in particular for thermal neutrons. However, like all known absorbers, it exhibits strong neutron-induced expansion which, in the long term, leads to destruction of the absorber enclosure. Another absorber which can be employed is, for example Ag ln Cd, or a material containing boron which is enriched with the isotope B-10.

It is particularly preferred to employ B₄C with less than 70% of a theoretic density, particularly of less than 60% because swelling of the absorber can be initially prevented in this way, and a particularly high burn up percentage αₘ of the employed absorber material is achieved. However, when optimizing the initial or starting B₄C -density, it is necessary to make sure that the absorber still has a sufficient amount of B-10 atoms so that the criterion of the effectiveness can be satisfied.

The absorber enclosures are preferably constructed in such a way that they include a plurality of part segments, whereby the part segments of the absorber enclosures are dimensioned in such a way that the part segments of the adjacent absorber enclosures, in particular their abutting surfaces are arranged displaced against each other. The use of several part segments permits easier handling, and by providing the part segments or at least one part segment that is inserted first with different dimensions, the abutting surfaces of adjacent absorber enclosures will not be disposed directly next to each other, which avoids creating a weak point.

Such control elements are preferably employable in boiling water reactors and pressurized water reactors. In boiling water reactors, the control elements are normally constructed from four wings arranged in the form of a cross, such wings having up to 21 absorber enclosures structured in a concentric form. On the other hand, control elements referred to as control assemblies are normally employed for pressurized water reactors and are driven into the core from the top. The control element as defined by the invention can basically be employed for all types of reactors in which such an absorber is used.

With the control element of the invention, it is possible to accommodate the swelling of the absorber without the failure of the outer most absorber enclosure. Thus the control element as a whole can be used for an extended working life and almost all of the absorber material can be exploited in the ideal case at locations, were the neutron fluence shows a maximum. Model computations have shown that it is possible with the control-element of the invention to achieve with the use of B₄C as the absorber a burn up percentage αₘ between 90% and 100%, and actually of 100% under favorable conditions.

### BRIEF DESCRIPTION OF THE DRAWINGS

Other objects and features of the present invention will become apparent from the following detailed description considered in connection with the accompanying drawings which discloses several embodiments of the present invention. It should be understood, however, that the drawings are designed for the purpose of illustration only and not as a definition of the limits of the invention.

In the drawings, wherein similar reference characters denote similar elements throughout the several views:

FIG. 1a shows a 99% theoretical density pellet irradiated to≈3,5% ¹⁰B burn-up at 865° F. (80X) disclosed in the prior art;

FIG. 1b is a schematic representation of a nuclear cell in a boiling water reactor;

FIG. 2 is a top view of a control element;

FIG. 3 is a cross section through an absorber enclosure of a control element of the invention;

FIG. 3a shows a perspective view of the absorber rod;,

FIG. 4 is a graph showing the “critical”, local burn up distribution of a standard control element at the start of washout;

FIG. 5 is a graph schematically showing the burn up percentage αₘ and the local burn-up distribution α(r) of a control element according to the invention; and

FIG. 6 is a graph explaining the achievable burn up.

### DETAILED DESCRIPTION OF PREFERRED EMBODIMENTS

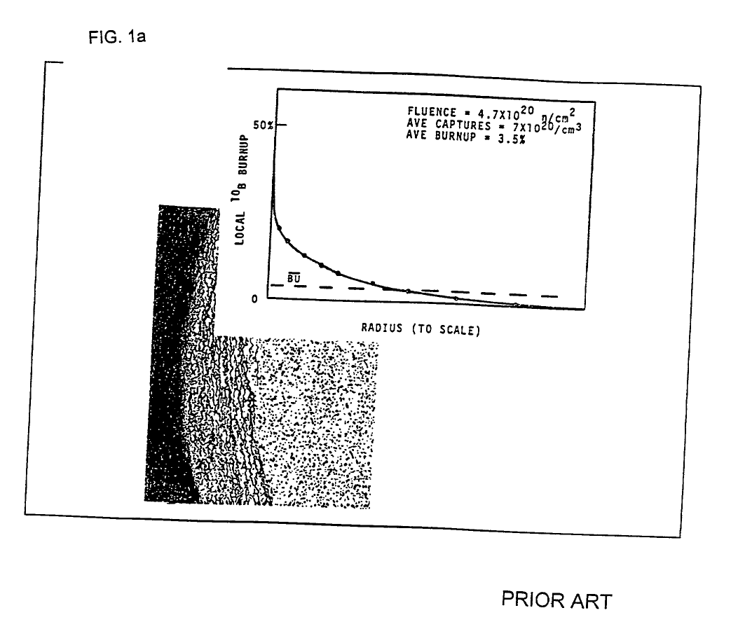

Turning now in detail to the drawings, FIG. 1a shows the burn up percentage αₘ (originally titled “AVE BURNUP \overline{BU}”) of an absorber pellet together with an illustrative local B-10 burn up distribution α(r) with respect to the radial absorber radius as from A. L. Pitner and G. E. Russcher in “IRRADIATION OF BORON CARBIDE PELLETS AND POWDERS IN HANFORD THERMAL REACTORS”, Wadco Corporation, Richland, Washington December 1970, UC-25, Metals, Ceramics and Materials in 1970.

FIG. 1b shows a schematic representation of a nuclear cell in a boiling water reactor, with four fuel elements 3 including the fuel element boxes 2 and a control element 1. The fuel element boxes 2 each surround a fuel element 3. The fuel element is arranged in a square, whereby a gap remains between the individual fuel elements 3. Thus a total of one cross-shaped control element 1 can be moved between the fuel elements. A free water gap remains between the fuel element boxes. The fuel element boxes 2 are supported by a top nuclear grid (or gate) 4 and a bottom nuclear grid 5. Control element 1 has a multitude of rods 7, which are filled with an absorber 8. Control element 1 is lowered or raised as required between the fuel element boxes 2, so that a controlled chain reaction (k_{eff}=1) is maintained. Control element 1, furthermore, is constructed in such a way that it immediately can be completely raised, if necessary, so that the chain reaction can be immediately stopped in any situation.

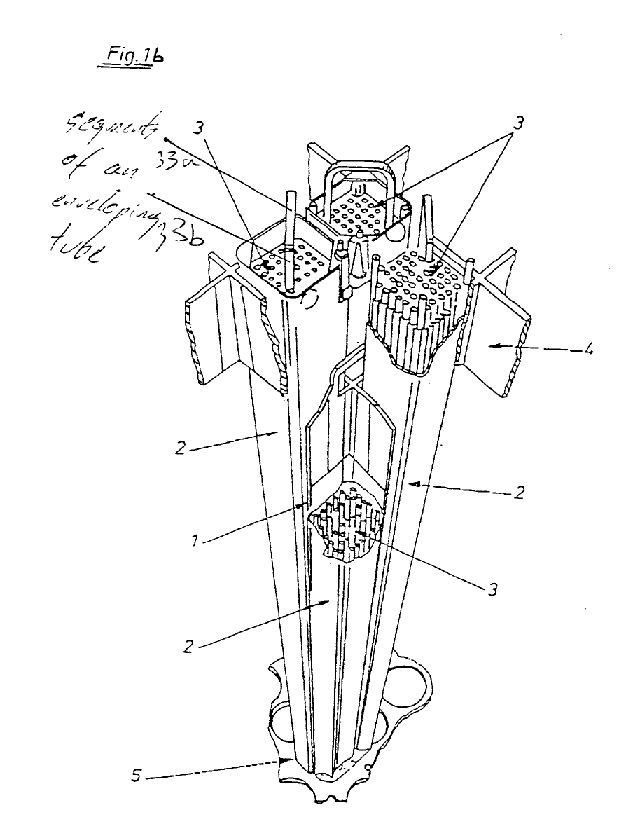

FIG. 2 shows a top view of a control element 1 as it can be employed, for example in a boiling water reactor. Control element 1 has four wings 6 arranged in the form of a cross. The wings have up to 21 absorber rods 7, which are filled with boron carbide (B₄C) powder. B₄C is preferably used as a neutron absorber 8 because of its favorable physical and technological properties. The absorber enclosures 7 have a sheet metal jacket, which assures mechanical integrity. The rods 7 are an elementary component of the control element 1. This is because contrary to original assumptions, such rods 7 cannot be used over the entire useful life of the reactor. Instead, the rods 7 must be viewed as a consumable material. Thus after only a few operating cycles, neutron-induced expansion or swelling of absorber 8 of up to 15% by volume causes mechanical damage to rod 7 with a subsequent washout of the absorber material 8.

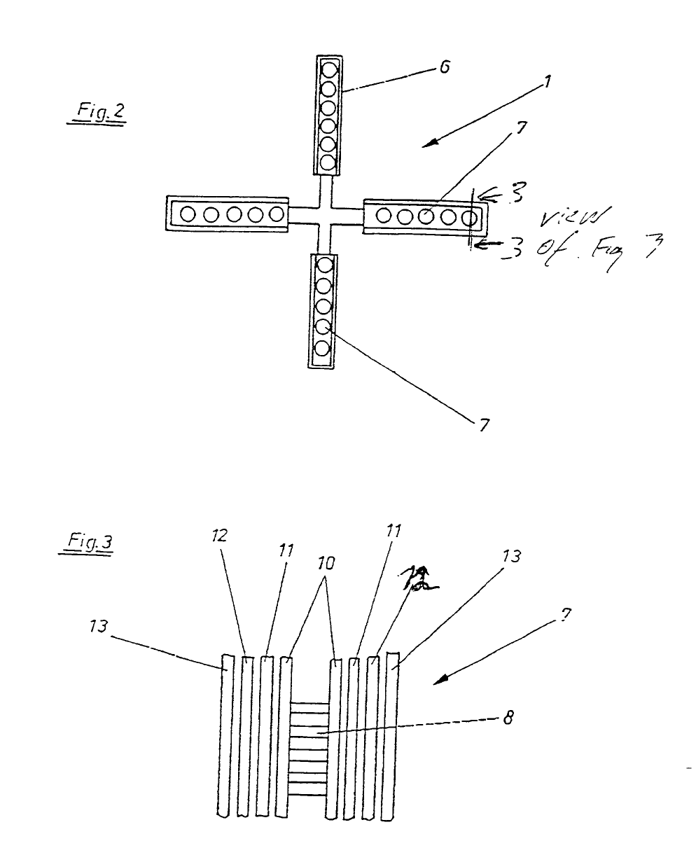

FIG. 3 shows a cross section of FIG. 2 through an absorber rod 7 according to the invention, by which even a strongly swelling or expanding absorber 8 can be safely supported for a particularly long time. The employed absorber material can be subjected to a burn up percentage αₘ of almost 100% without the burnt-up B₄C and thus without the tritium also getting into the reactor coolant. Absorber 8, which can be used also in the form of a powder, is provided in FIG. 3 in the form of sintered B₄C tablets. These tablets are received in a first and inner absorber enclosure 10.

The B-10 reaction will start directly at the location of the outer B4C surface to indicate massive circumferential stress as described in detail (See FIG. 1A): During exposure the reaction plane starts to move to the central absorber axis step by step by following an exponential burn up expression and by forming a solid ceramic structure growing and showing a lower density during this procedure. The original free volume of 30% (B₄C 70% of a theoretical density) at the beginning of the exposure event is not completely available for swelling accommodation. This is because the forces acting on the inner wall of the absorber enclosure will increase as the solid ceramic structure zone is being formed by changing the original grain size into fragmented small particles being baken together during exposure to thermal neutrons.

However, the rate of creep deformation of the absorber enclosure is very low as compared to the rate of absorber growth (Δε (enveloping tube)/Δt<<Δr (absorber radius growth)/Δt). Hence, the swelling behavior of the absorber respectively and, the local density reduction, will be adjusted in a proportional relationship to the radial burn-up distribution α(r) with respect to the absorber axis of the cylindrical absorber and thus to the applied thermal neutron fluence (Φ=₀¹∫flux dt.

After exceeding a critical neutron fluence Φ_{crit}, i.e., the amount of captured neutrons required to cause the absorber to swell by a certain measure, and upon exceeding the critical expansion limit of the absorber enclosure, the innermost absorber enclosure 10 fails and breaks until the absorber has built up a critical pressure at a radial burn-up distribution α(r)=α(r)_{crit} respectively at a burn up percentage αₘ=α_{mcrit} (See FIG. 3A). The pressure within the B₄C absorber 8 is first reduced and then relieved by such failure to a very significant extent. With further exposure to neutrons, absorber 8 has again built up a critical pressure after another critical neutron fluence has been absorbed. This critical pressure exceeds the expansion-breaking limit of the first middle absorber enclosure 11 and thus causing failure of the first middle absorber enclosure 11 as well. Provision is made for a minimum spacing between inner absorber enclosure 10 and first middle absorber enclosure 11. This minimum spacing corresponds with the expansion limit of the inner absorber enclosure 10. Therefore, any failure of the inner absorber enclosure 10 leaves undamaged the first middle absorber enclosure 11, which surrounds absorber enclosure 10 and which is positioned at a spaced distance from the outside of inner absorber enclosure 10.

The expansion of absorber 8 continues to progress in this way also up to the second middle absorber enclosure 12 and up to the outermost absorber enclosure 13. Absorber enclosure 13 forms the outer wall of the absorber rod 7. Therefore, there are several absorber enclosures nested one inside the other and spaced one after the other. The B-10 burn up percentage αₘ increases as the number of absorber enclosures increases by a certain amount. This increase is a function of the absorber enclosure deformability with respect to the deformation strain at the expansion limit and the number of absorber enclosures, in order to finally reach the 100% B-10 burn up limit of αₘ. As described before, B₄C absorber 8 normally is fixed to a theoretical B₄C density of 70%. Thus a free volume of up to 30% will be available for swelling accommodation during the exposure -process step by step in accordance with the number of absorber enclosures and their deformabilities with respect to the deformation strain at the expansion limit.

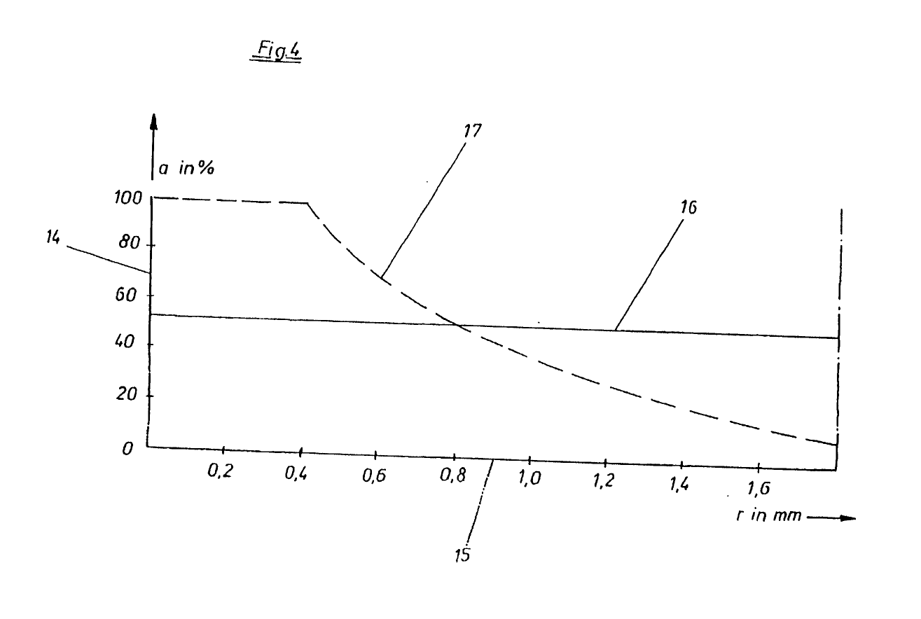

FIG. 4 shows exemplarily in a graph the B-10 burn up distribution α(r) in % as a function of the absorber radius r in millimeters mm of the standard absorber rod design where the burn up percentage αₘ=α_{mcrit}, that means, in a time at which the applied neutron fluence is so high that the critical case occurs, i.e., failure of the absorber enclosure. The burn up distribution α(r) is plotted in percent (%) on the y-axis denoted by reference numeral 14. Reference numeral 15 denotes the x-axis, on which the absorber radius is plotted in millimeters (mm). The line denoted by 17 reflects the critical burn up distribution α(r)_{crit} for a standard control element with one single absorber enclosure. Absorber 8 has a radius of approximately 1.75 mm. It becomes clear that a 100% burn up region is produced only in an outer marginal zone, where the B₄C-absorber has caked into a hard ceramic structure, and where the free volume of 30% originally available there has been completely consumed. Adequate free space is still available in the interior, so that the absorber available there has not been used effectively. The fully drawn line 16 shows the burn up percentage αₘ=α_{mcrit}, based on the absorber cross section. For such an absorber enclosure, the burn up αₘ comes to about 50%.

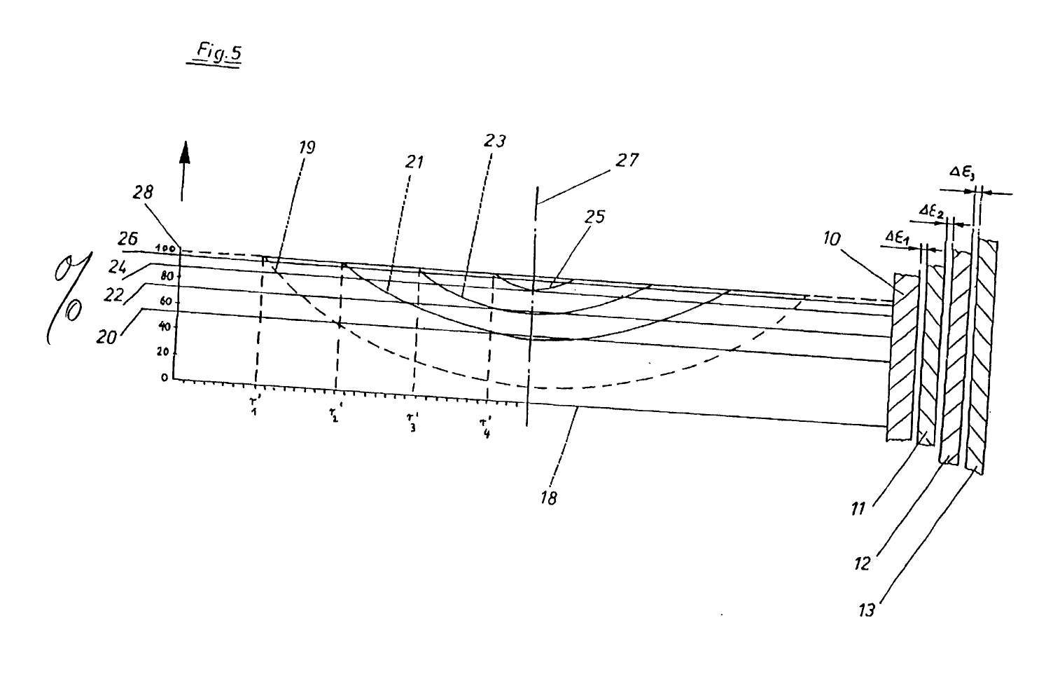

FIG. 5 shows in a graph the critical burn up distribution α(r)_{crit} in % and the related burn up percentage α_{mcrit} for an absorber enclosure according to the invention. The critical burn up distribution α(r)_{crit} is plotted in percentage (%) in this graph on the y-axis denoted by reference numeral 28, versus the radius plotted on the x-axis denoted by reference numeral 18. After the first critical fluence has been reached and the break up of the inner absorber enclosure 10 connected therewith has occurred, the critical burn up distribution α(r₁)_{crit} reflected by outer line 19 ensues. This distribution substantially corresponds to the one shown in FIG. 4. This results in the related critical burn up percentage αₘ_{_{lcrit}}, reflected by the fully drawn line 20, which comes to about 50%. Complete burn up of 100% is present in the outer region from 0 to r_{1′}. When a second critical fluence is reached and the break up of the first middle absorber enclosure 11 has occurred in connection therewith, the critical burn up distribution α(r₂)_{crit} denoted by reference numeral 21 ensues. At this point, the hard ceramic zone has then already expanded up to region r_{2′}. In the interior region, the local burn up has strongly increased as well as compared to the time of the first critical fluence. The related critical burn up percentage αₘ_{_{2crit}}, already comes to well over 70% and is reflected by line 22. Breakage of the third enveloping tube causes a critical burn up distribution a(r₃)_{crit} according to line 23, and a related critical burn up percentage αₘ_{_{3crit}}, according to line 24 amounts to about 90%. When the fourth critical fluence is reached, only a small residual zone of the absorber remains where it has not yet caked into a hard ceramic structure. This corresponds with line 25 in the region of symmetry axis 27. At this point in time, a related critical burn up percentage αₘ_{_{4crit}} according to line 26 ensues, amounting to almost 100%.

For illustration purposes, absorber enclosures 10 to 13 are shown as well, whereby lines 19 and 20 are associated with the inner absorber enclosure 10; lines 21 and 22 are associated with the first middle absorber enclosure 11; lines 23 and 24 are associated with the second middle absorber enclosure 12; and lines 25 and 26 are associated with the outermost fourth absorber enclosure 13. Spacing ε required between absorber enclosures 10 to 13 is shown again in FIG. 5 in this representation as well. This spacing is fixed depending on the expansion limit of the progressively closest or next inner absorber enclosure.

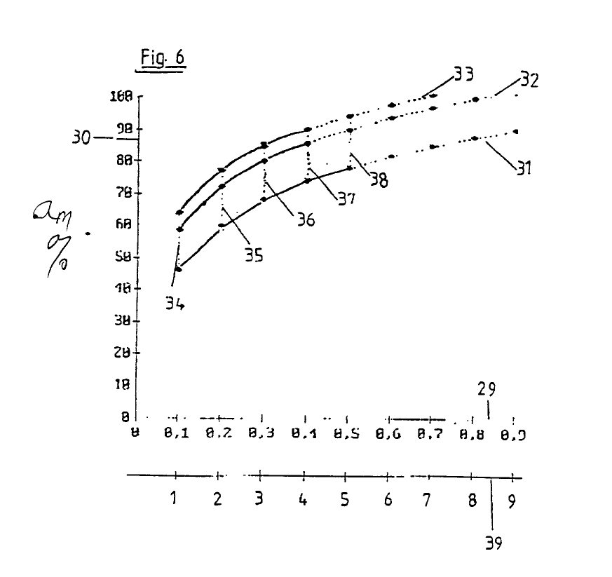

In FIG. 6, burn up αₘ, is plotted in percentage (%) on the y-axis denoted by reference numeral 30. The added-up wall thickness of all absorber enclosures is plotted in mm on the x-axis denoted by reference numeral 29, whereby it was assumed that each absorber enclosure has a wall thickness of 0.1 mm. The number of absorber enclosures is supplementarily plotted on a second x-axis 39. The burn up percentage αₘ, that took place in this connection was computed according to the microscopic burn up theory. Here it was assumed in connection with curve 31 that the absorber material, namely B₄C, has 70% of a theoretical density. Then 50% of a theoretical density was assumed in connection with curve 32, and 50% of a theoretical density was assumed in connection with curve 33. It was assumed, furthermore, that the inside radius of the B₄C comes to 3 mm in the present case.

However, it is noted that the calculations show that the values determined for burn up percentage αₘ, are independent of the inside radius of the B₄C material, which, therefore, means that absorber enclosure with an inside radius of, for example 2.7 mm can be successfully employed as well. Curve 31 shows that the first absorber enclosure with 0.1 mm wall thickness would already fail at a burn up αₘ of about 45% in the position denoted by 34 with 70% of a theoretical density. The second absorber enclosure, which has a wall thickness of 0.1 mm as well, would permit a burn up αₘ of barely 60%, which is shown in the position denoted by 35. A burn up αₘ of about 65% is achieved with a third absorber enclosure, as can be seen in the position denoted by 36. A burn up of approximately 70% ensues for a fourth absorber enclosure in position 37, which corresponds with an accumulated neutron fluence of about 5.95×10²¹ n/cm².

By using additional absorber enclosures, it is possible to increase the burn up percentage αₘ further, as follows from the line denoted by 31. The use of lower theoretical densities results in a higher burn up percentage αₘ, which follows from the curves denoted by 32 and 33. For example, with 50% of a theoretical density (curve 33), a burn up am of more than 80% is achieved already with the third absorber enclosure (position 36). A burn up αₘ of 90% is obtained already with the fourth absorber enclosure, which corresponds with an accumulated neutron fluence of 8.3×10²¹ n/cm² as follows from the position denoted by 37. The individual absorber enclosures have a wall thickness of 0.1 mm. A space of about 0.01 mm remains between the absorber enclosures. If the latter are designed with different wall thicknesses, for example the inner three absorber enclosures each with a wall thickness of 0.1 mm and a fourth outer absorber enclosure with a wall thickness of 0.5 mm, this would be more favorable overall than having a wall thickness of 0.5 mm for the innermost absorber enclosure and a wall thickness of 0.1 mm for each of the three outer absorber enclosures.

The design of the control elements according to the invention, can be computed with the help of the microscopic burn up theory, and which has been verified also by different measurements. This shows that the pressure load acting on the control elements is basically determined by the B₄C expansion due to swelling. The designs to date only permit a B-10 burn up percentage αₘ of approximately 50%. In order to cover local neutron fluence increases, however, it is necessary to make sure that a local B-10 burn up αₘ of up to 100% will not lead to failure of the absorber enclosure. This is accomplished with the present invention. If need be, the control element according to the invention also can be fitted with a plurality of absorber enclosures exclusively in the regions where the neutron fluence is excessive. These regions are particularly in the upper regions and in the marginal zones of the wings of the control elements.

Accordingly, while a few embodiments of the present invention have been shown and described, it is to be understood that many changes and modifications may be made thereunto without departing from the spirit and scope of the invention as defined in the appended claims.

What is claimed is:

1. A control element for a nuclear reactor comprising:
a plurality of absorber rods (7) each absorber rod (7) comprising at least an inner absorber enclosure (10), an outer absorber enclosure (13) and a first middle absorber enclosure (11), wherein the absorber enclosures are fitted and nested into each other and concentric in their relationship;
a predetermined spacing between each of the absorber enclosures surrounding and adjacent to one another; and
an absorber (8) contained only within the inner absorber enclosure (10);
wherein, in the event of expansion of the absorber, a respective absorber enclosure is removable from a starting position and a mechanical resistance is formed for compressing and containing the absorber.

2. The control element according to claim 1, wherein the outer absorber enclosure is at least partly around the middle absorber enclosure which is around the inner absorber enclosure.

3. The control element according to claim 1, wherein the outer absorber enclosure is completely surrounding and enclosing the inner absorber enclosure.

4. The control element according to claim 1, wherein there are four absorber enclosures (10, 11, 12, 13), comprising said inner absorber enclosure (10) and said outer absorber enclosure (13) spaced from said inner absorber enclosure and said first middle absorber enclosure (11) positioned between and spaced from said inner and outer absorber enclosure; and
a second middle absorber enclosure (12) positioned between and spaced from said first middle absorber enclosure and said outer absorber enclosure.

5. The control element according to claim 1, wherein dimensions of the inner absorber enclosure are selected in such a way that the inner absorber enclosure receives preset sintered absorber tablets.

6. The control element according to claim 1, wherein B₄C is used as absorber.

7. The control element according to claim 1, wherein the absorber has less than 70% of a theoretical density.

8. The control element according to claim 1, further comprising a boiling water reactor, and said control element (1) is a component of said boiling water reactor.

9. The control element according to claim 1, further comprising a pressurized water reactor, and said control element (1) is a component of said pressurized water reactor.
